(19) United States
(12) Patent Application Publication
(10) Pub. No.: US 2018/0039681 A1
(43) Pub. Date: Feb. 8, 2018

(54) Method of organizing multiple hierarchical data structures in a single normalized structure of relational database for automation of data process design and for discovery analysis.

(71) Applicant: Sergey Gavryushenko, Brooklyn, NY (US)

(72) Inventor: Sergey Gavryushenko, Brooklyn, NY (US)

(21) Appl. No.: 15/230,500

(22) Filed: Aug. 8, 2016

(51) Int. Cl. G06F 17/30

(52) U.S. Cl. CPC G06F 17/30563; G06F 17/30589; G06F 17/30595

(57) ABSTRACT

The invention is in Data Architecture (DA) area of Information Technology (IT) and presents a new method of building a common data structure for descriptive data in order to automate significant volume of design and development in IT data processing, as well as to provide a dynamic Information Analytical Base (INFABASE) for real discovery analysis vs. slice-and-dice predefined dimensions: by changing data in such structure users can change data processing and analysis, which means that there is no need for application changes while users can try their ideas, for example if user wants to change the definition of dimensions to something absolutely new and without a project and without detailed knowledge of the tables behind (long expected “sand-box” feature).

The invention is based on “adjacency list” approach.

### BACKGROUND

The invention is in Data Architecture (DA) area of Information Technology (IT) and presents a new method of building a common data structure for descriptive data; using such structure can lower cost of development and maintenance for data processes in Extract-Transform-Load (ETL) and in user facing applications; it also provides users with real “sand-box’ functionality: no need for lengthy and costly projects to change or create a hierarchy, which determines the data processing, reporting or analysis.

### The Need for the Invention

Modern Information Technology (IT) has many application data processes (processes from now on). Most of these processes are doing Extraction, Transformation and Load of data (ETL) and interact with users. Number and complexity of processes keeps growing, as well as the cost of maintenance due to changing business needs and external requirements, such as legal, industry compliance, customer needs. It is especially true for descriptive data, often organized in hierarchies of departments, products, etc. One of the ways to reduce labor cost is to automate development and design, which will add efficiency to data management, shorten delivery time and improve the user experience, especially for power-users. The goal of the invention is to provide such common data structure, in which the changes can be done without redesign, just by DML operations (insert, update, delete) on content of the structure, without repointing application codes to new objects, and with a common well-known structure of descriptive information instead.

One of reasons why automation of design is not done is absence of a practical solution for a common data structure that could hold different types of descriptive information and element. Modern tools (Informatica, Business Objects, Cagnos, etc.) need developers to point code to specific physical data structures and added or changed columns in the structures, and imbed the meaning of that (hierarchical and not) in processing logic, which effectively “hides” the logic, disperses it in the entire application, making the need for a human eye inevitable for any further change. The invention presents one of the structures to lower IT cost of development.

### Novelty of this Invention

A common practical solution that provides a simple uniform structure for descriptive information is unknown yet and it will push automation of IT development.

Since mainframe computers we do know a very good solution for transactional data: it is transactional files with separate customer files, which later in databases transformed into transactional, fact and dimension tables. All data architects and modelers are so used to transactional/fact tables that do not even recognize it as solution.

The solution for transactional data that we use now, as fact-tables in dimensional design and as transactional or factual tables in normalized design, belongs to accountants who ran their books for centuries by separating transactions from detailed description of contracts and, at the same time, by splitting transactions into two sides: debit and credit (T-accounting today). This allowed a perfect accounting for transactions because all of them (buy, sell, depreciation, debt, etc.) could be held in a common (T-like) structure without its “redesign”: same books for any new transaction, and with only difference in one attribute, direction: debit or credit. At the same time separated and widely varied descriptive information (types of contracts, products, conditions, etc.) was left without a similar solution; it was not needed at the time. This is one of the reasons why any common solution for descriptive data is new and innovative, allows for further progress. There are many specific-solutions, for example “Dynamic creation of product structure” in publication number “US 20100058218 A1”, but no sufficiently universal solution. There are few more reasons why descriptive data remains without a common solution in age of computer systems, and would be highly innovative and beneficial now. One of them is much smaller size of descriptive data in comparison to transactional data, while storage size used to be driving the cost but now process changes are more expansive. Another reason why we do not have a solution for descriptive data lays in historic IT needs: there were no needs to automate development till 2000th. Since late 1990^{th} the data architecture design community is focused on two different approaches to data architecture: dimensional design (facts and dimensions) versus normalized (mostly 3^{rd} Normal Form, or 3NF); both approaches satisfy the short term needs but lose business perspective and converge to similar structures in practice; mixed design is reality and the more design is needed the better for IT, but not business. The 3NF design never denied use of transactional or “event” tables (facts in dimensional design), while dimensional design very often has to convert dimensions into somewhat normalized hierarchical form, known as snowflakes. The 3NF always had “bridge” or mapping tables and dimensional design introduced equivalent. The commonality between them—both have a universal common structure for factual data (facts/events), and both do not have a universal common structure for descriptive data. Prevailing design for descriptive data is fixed (fixed levels, and table per level or column) and needs manual redesign: if a new level, for example regions, is added to a prior company structure of departments, managers, and workers, then in both designs, dimensional and normalized, a new data structure (table) or columns is most likely to be created to represent that new level of management, the regions. Such change implies human interference: redesign of structure, repointing to them from applications, re-testing of impact, etc. Other well-known approach is variations of recursions, one of which (“adjacency list”) might be considered as the starting point of this invention. Torn Houghey, one of the most famous data architects, described these options in his work “Recursion in Data Modeling” (reference #1 in non-patent citations) that can be downloaded from http://erwin.com/community/industry-expert-blogs/recursion-in-data-modeling-part-2/. This article from 2011 tells us the current state of the matter.

Another reason for novelty and not obviousness of the invention is business specific: corporate management needs to reduce or hold the IT maintenance cost, but is not able to because corporate managers are not the, specialists in the subject, while IT management and developers could but are not interested in it: additional work and IT reduction as its result. Companies that produce new tools for developers are also not interested in automation of development. This status remains unchanged since about early 2000^{th}, for about over ten years, which is a generation in IT and proves that the solution is not obvious. The invention suggested is one of the solutions needed to lower IT costs, increase quality and robustness with introduction of automation into data-process development.

### DESCRIPTION OF THE INVENTION

The invention suggests a common data structure that can handle (add, remove, modify, combine) different hierarchical information used in business IT.

The solution combines:

(a) ease of adding different kinds of descriptions into the same structure (with Data Manipulation Language operations, DML);

(b) normalization and stable structure so that information is entered in the structure once and its location is predictable;

(c) recursive relations, which accommodates the very practical situation for frequent, business situations where an element, with time, can become a structure of some kind, or a structure can become an element in other structure;

(d) ability to create dynamically (with just DML language operations within the structure) structures of interest to users based on sub-sets of elements from different hierarchies.

### Brief Description

A data structure is presented as a set of Parent-child relations between elements (this is similar to “adjacency list”); however, any element can, in turn, be a complex structure by itself, and/or can be part of more than one structure, and any relation can point to elements of different origin (base); any relation can be linked to an entire Element Base or few. Such structure joins benefits of “adjacency list” with new features added to allow for automation of design and development in IT data processing and applications, and for empowering business users to try what they want without projects (old idea of “sand box” for business, vs. for IT). The additional features include diversity of elements and relations, creation of overlapping hierarchies, and link relations to Element Bases,—all together create a single, common Analytical Base (INFABASE) for information automated acquisition (without additional design) and discovery analysis.

Discovery Analysis is emphasized because the innovation empowers users/processes to create their own hierarchies without any extensive project: by simple manipulation of records in the structure a hierarchy describing the information acquisition, processing or reporting can be change and, therefore, the process itself. Business users will be able to check their ideas which they rejected before due to costly and time consuming, projects. As of now, business users “drill” the well-known dimensions in their line of business, in other words they walk the same streets others do, and, therefore, unlikely to discover something new, and “slice and dice” technology became reporting or operational troubleshooting technology. To discover something new and actionable, business users need the ability to redesign dimensions, “walk diagonally” if needed, for which they need the flexibility of creating and changing hierarchies fast, while the idea is there.

### DETAILED DESCRIPTION

The solution can be considered as based on “adjacency list” and is as following:
1) A structure is presented as a set of relations between elements; one record of the STRUCTURE entity can point to one or more relation records of RELATION entity
2) Each relation has a “parent” and a “child” element of the relation; therefore, one record in RELATION entity always points to two records in ELEMENT entity, one points to parent element of the relation and another one points to child element in this relation; pointing to the same element as the parent and child is not supported. Each element can be part of more than one relation and an element can have more than one parent.
   The structure described to this point, in “1)” and “2” is very close to a well-known “adjacency list’ structure, beautifully described, for example, in “Recursion in data modeling” by Tom Haughey (http://erwin.com/community/industry-expert-blogs/recursion-in-data-modeling-part-2/). It's so well-known that does not need to be proved by any code samples, however, its benefits need to be noted as some of them will change in this invention:
      a. Designed for non-cyclical structures, and the same for the invention.
      b. Allows for changes (to the hierarchies stored) to be done without re-design of the structure (no designers intervention is needed), just by adding, removing or changing records in ELEMENT and RELATION entities. This advantage remains in the invention.
      c. Holds multiple simple hierarchies (all elements but one are child elements, in at least one of its relation, elements are of the same nature, each element can have only one parent). The invention changes this limitation by expanding from simple hierarchies in scope to structures where an element can have multiple parents and structures that consist of, multiple hierarchies.
3) Each element has an Element Base that reflects a nature of the element or of a set of elements, and, therefore, more than one ELEMENT record can point to the same record in ELEMENT BASE entity. Multiple element bases are needed in business, for example, different resource contract base, different product or profit bases, locations, etc.
4) Any relation can have parent and child elements from different Element Bases, and any element can be part of a relation in any number of structures (hierarchies in per “adjacency list” terminology). This allows for very dynamic and so much needed today “multi-top structures, when one pyramid-like simple hierarchy overlaps with another by elements or/and relations. Example a project team comprised from employees of one company and from a vendor company,—dual reporting is, a norm today. Similar situation with matrix-like environments, when the same resource is used by and reports to different departments. Similar for commissions to the same employee from different projects, profits from different bases and contracts, and many more.
5) Any element can be (or become) an entire new structure of from the same or different elements, as often needed in business. This is why a record from ELEMENT entity can point to zero, one or more records in STRUCTURE entity.
   For example, a financial trade “option” was a simple product at first, an element in some product hierarchies, and in few years it developed into “derivatives” set of financial products, with its own dependencies on other product mixes. Another example, an employee on an HR hierarchical structure might be a head of Fired Warden Team (another structure) also. Very often there is a need to know such dependencies for compensation, for influence of account, for intelligence and security: influence on account by a person or entity; decision making influence on a project through peers relations not depicted in HR but in social network, and many other examples. This might look like influence diagram on a report or as a drill-down capability in data mining tools, while adding or changing all these capabilities do not need, database structure re-design.
6) Any relation can be a cause of, existence or be relevant to an entire Element Base. This functionality is yet rarely used, however, such relations might be a cause for many important criteria and results in business, and, therefore, are very important for data mining, for actionable analysis and discovery.
   For example, and analysts looking for performance improvement placed all employees in manager/other “buckets”, and results are inconclusive, because what is “manager” for performance analysis is not a simple HR title. Such analyst would add a contract type structure (corporate/officers, middle management, employees with options, no options employees), link it to ‘employee” Element Base and discover that performance depends on what employee sells to the company: time (8 hours day) without options, time with minimal options, options with company-wide performance indicators, contract with specific indicators (corporate) or projects (vendors). Such analysis might convince to split the “employee” Element Base into few more (“corporate”, officers, middle management, etc.). Another example—an analyst discovers some groups of sequential elements (subset of elements with one parent and one, leave) in a process structure, combines them and creates a new set of element bases (rolls up few sequential into a single, element type).

### SUMMARY OF THE INVENTION

The invention provides the method to automate significant volume of design and development in IT data processing, as well as a dynamic Information Analytical Base (INFABASE) for discovery analysis, vs. slice and dice predefined (by industry or by IT staff) in dimensions: users can change descriptive data, which defines the data processing and analysis, with a simple DML operation, which means no need to change application while users try their ideas; for example, users can change a definition of a dimension to something absolutely new and without project or detailed knowledge of the tables behind (long expected “sand box” feature).

The invention is based on “adjacency list” approach.

### LIST OF FIGURES

FIG. 100. The recursion implementation as “adjacency list” from “Recursion Data Modeling” article by Tom Haughey; internet publishing address as of Aug. 7, 2016; http://erwin.com/community/industry-expert-blogs/recursion-in-data-modeling-part-2/ This is the closest to the invention prior work known to me, and I use it in detailed description for comparison.

FIG. 200. The invention Data Structure in format of natural Primary Keys propagation, executed in Erwin data modeling tool.

FIGS. 300 and 400 are examples of how the invention being claimed can be used.

FIG. 300. An example of three independent (at first glance) complex hierarchies that can be created without changes to the Entities of the data structure being claimed as invention, and where each can hold elements of different Element Base (circle shaped elements in the example represent “employee” base, triangle represents “consultant”, square represents external vendor employee). Elements also can have multiple parents, as element “6” has, and each hierarchy can be built from elements of different base: employee, consultant, vendor employee.

FIG. 400. An example of combining the hierarchies (shown on FIG. 300) for analysis into a single structure, where dashed relations show the join-venture project between a company and a vendor company, while solid-line relations represent direct employment (with a company or with a vendor company). Resulting hierarchy can have more than one top (manager “1” from the company and manager “21” from vendor company), it is also possible to have “parallel” relations of different type (belongs to different structures), which are very useful to discover in business analysis.

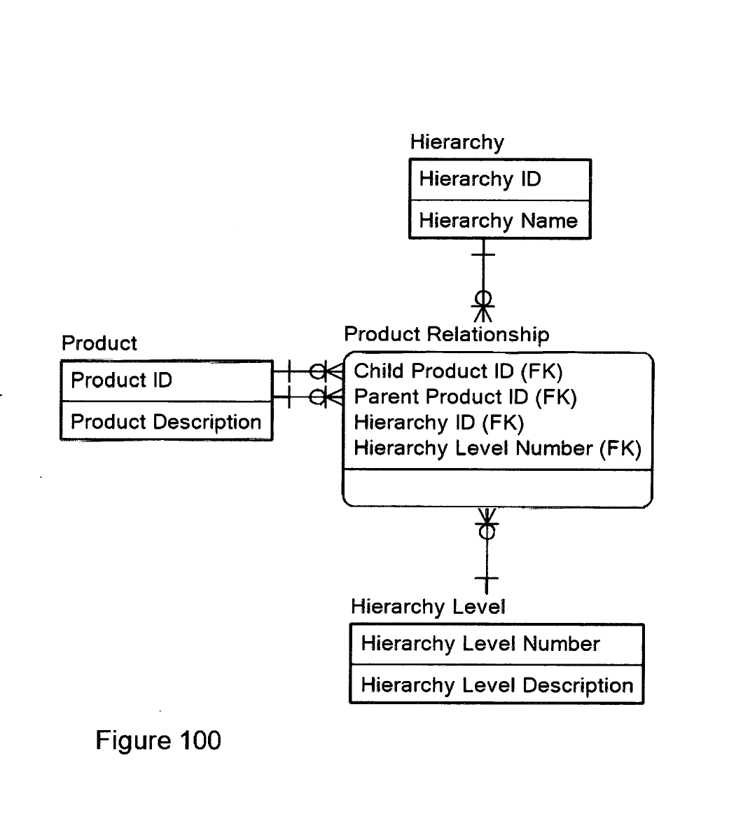

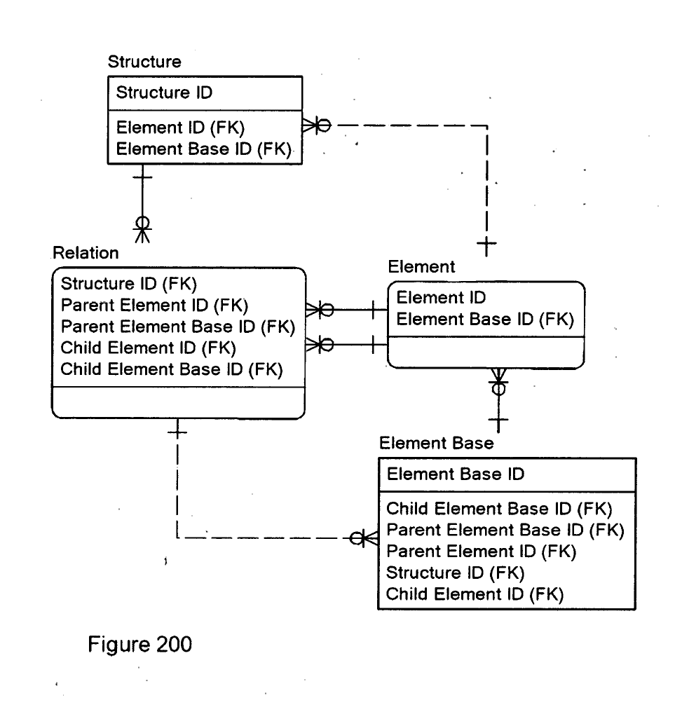

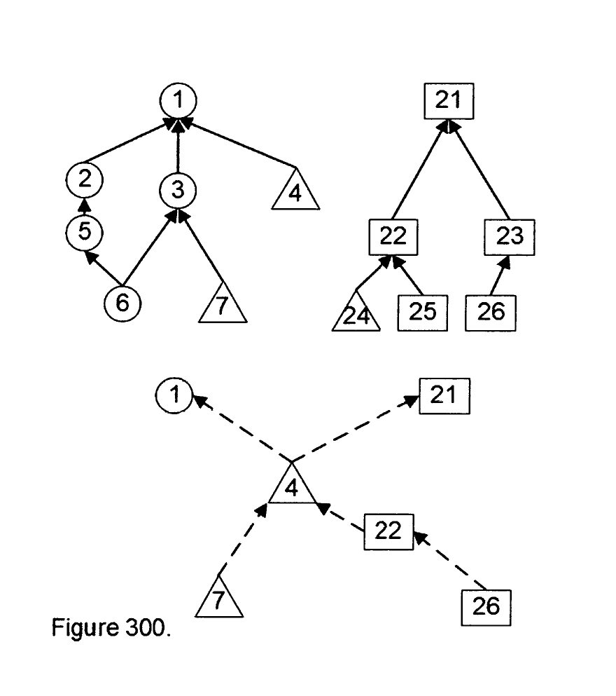

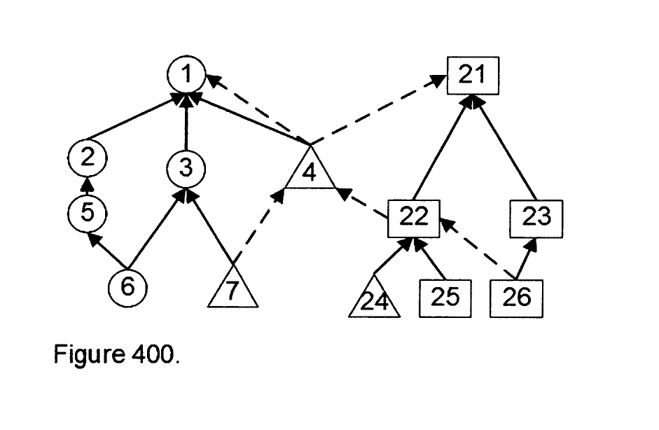

1. Method of organizing multiple hierarchical data structures in, a single normalized structure of relational database for automation of data process design and for discovery analysis comprising:
at least one Element Base record in the ELEMENT BASE records entity (can be table in relational database), where each such record has a unique identifier (Element Base ID) and identifies the nature of elements by being a parent in identifying relation with Element records in Element entity;
at least two Element records in a records entity ELEMENT,where each record has a uniquely identifying field or a set of fields that uniquely identify the element;
at least one Relation record in RELATION entity, where each record has a uniquely identifying field or a set of fields that uniquely identify each relation, and record also has two identifiers of elements participating in the relation, where one Element ID represents a parent element of the relation and other element ID represents the ID of the Child element of this relation and both Identifiers are required fields (can not be empty or unknown), and any Relation entity record can be a parent to ELEMENT BASE entity records due to non-identifying relation between RELATION and ELEMENT BASE entities with RELATION entity being the parent;
at least on Structure record in the STRUCTURE entity, where each such record has a uniquely identifying field or a set of fields uniquely identifying a structure record in the Structure entity, and each Structure record points to zero, one or more Relation records in Relation entity due to its identifying relation as the parent to Relation entity, where Structure is considered “empty” if it points to zero records in Relation entity, and a structure record can be child in non-identifying relation with an Element record due to non-identifying relation between ELEMENT and STRUCTURE record, in which ELEMENT entity is the parent;
at least one record per data structure (hierarchy) in Elements entity is only parent in all its Relation records, meaning that the Element Identifying field or fields (in case of multiple-fields key) point only to Parent Element ID in ELEMENT records.

2. A method of claim 1 further comprising:
A numeric attribute identifying the strength and direction of a relation represented by the record in RELATION entity, which allows for the same structure to represent relation strength and direction to represent structures with weighted relations and peer relations.
